(19) United States
(12) Patent Application Publication
(10) Pub. No.: US 2021/0388826 A1
(43) Pub. Date: Dec. 16, 2021

(54) ELECTROHYDROSTATIC DRIVE WITH AN EXTENDED OPERATING RANGE

(71) Applicant: Moog GmbH, Boblingen (DE)

(72) Inventors: Dirk Becher, Nufringen (DE); Tino Kentschke, Weil der Stadt (DE)

(21) Appl. No.: 17/287,454

(22) PCT Filed: Oct. 22, 2019
(86) PCT No.: PCT/EP2019/078721

§ 371 Date: Apr. 21, 2021

(30) Foreign Application Priority Data
Oct. 23, 2018 (DE) 10 2018 126 395.3

(51) Int. Cl. F04B 17/03; F04B 53/16; F16J 15/34

(52) U.S. Cl. CPC F04B 17/03; F16J 15/34; F04B 53/16

(57) ABSTRACT

Electrohydrostatic drive with an electromechanical drive with a rotating drive shaft and a first receiving unit, wherein the electromechanical drive is arranged in the first receiving unit. Furthermore, the electrohydrostatic drive comprises a pump unit and a second receiving unit, wherein the pump unit is arranged in the second receiving unit and the second receiving unit contains a transport fluid, and the first receiving unit and the second receiving unit are arranged in contact with one another, with the result that the electromechanical drive and the pump unit are connected to one another via the drive shaft. In addition, the electromechanical drive comprises a slide ring seal, wherein the slide ring seal is arranged along the direction of extent of the drive shaft, between the electromechanical drive and the pump unit, in such a way that the first receiving unit with the electromechanical drive and the second receiving unit with the pump unit are connected along the rotating drive shaft in a fluid-tight manner with respect to one another by way of the slide ring seal.

The present invention relates to an electrohydrostatic drive (EPU—electrohydrostatic pump unit) having a slide ring seal.

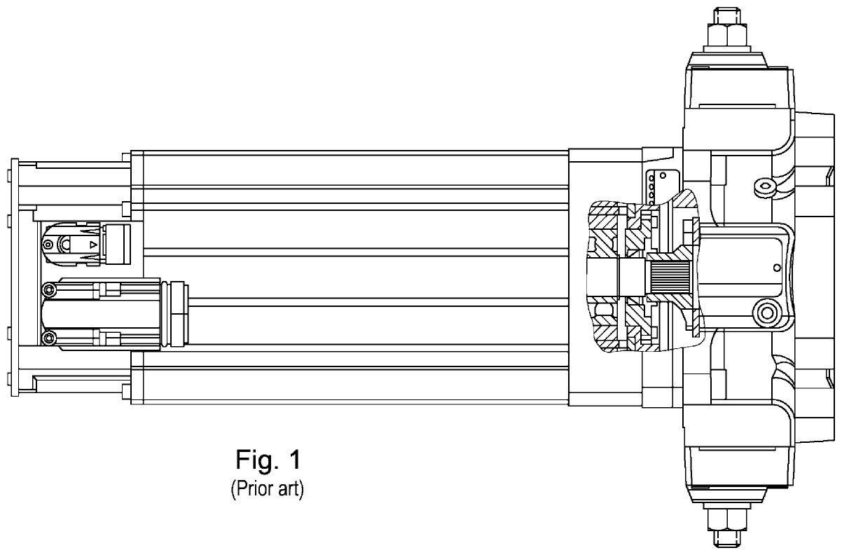

Electrohydrostatic drives are known in the prior art. An electrohydrostatic drive is understood to mean the direct coupling of an electric, speed-variable drive to a hydrostatic pump. The electric drive provides a mechanical drive power in the form of a rotational speed and a torque. The mechanical power provided is converted by the hydrostatic pump into a hydraulic output power, in the form of a volume flow and an operating pressure or a pressure difference across the working connections of the hydrostatic pump. In addition, the electrohydrostatic drive is capable of converting a hydraulic drive power into a mechanical output power at the electric drive during motor operation of the hydrostatic pump. Thus, in the electrohydrostatic drive, electrical power is converted into hydraulic power or energy and vice versa. A liquid, generally hydraulic oil, is used for energy transport in the hydraulic part of the drive train of the electrohydrostatic drive. Due to the function, a separation of the media of hydraulic fluid within the hydrostatic pump and air within the electric drive must take place. This sealing electrohydrostatic drives known in the prior art takes place in that a shaft sealing ring is mounted on the drive shaft between the electric motor and the hydrostatic pump. The sealing of the shaft sealing ring takes place on the non-rotating, static side via a positive fit, for example in the housing of the hydrostatic pump or the electric drive. Further sealing takes place dynamically relative to the rotating drive shaft via a sealing lip. An exemplary seal comprising the shaft sealing ring is shown in FIG. 1.

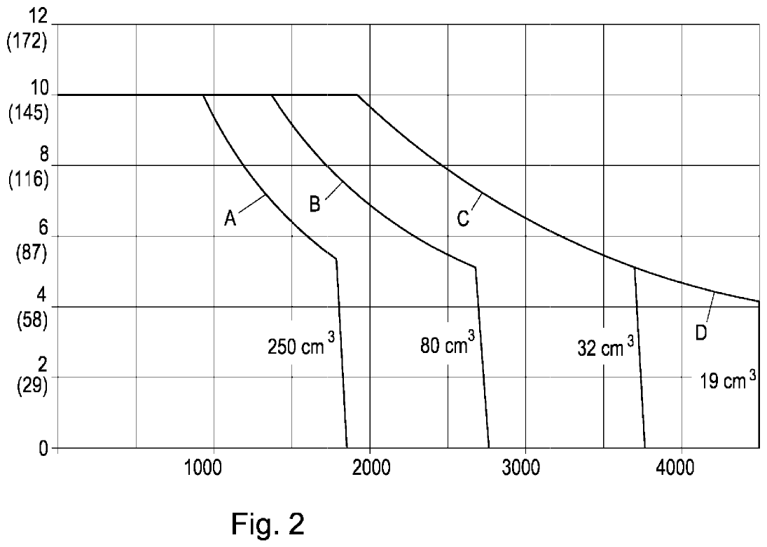

An electrohydrostatic drive with such a shaft sealing ring, as shown in FIG. 1, can be operated in a special form up to a maximum operating pressure of 10 bar. However, when the rotational speed of the drive shaft is increased, a reduction in the maximum operating pressure to approximately 4 bar occurs in this rotational speed range (see FIG. 2). Especially for the use of electrohydrostatic drives in an autonomous axle with an integrated differential cylinder, it is advantageous to have a higher housing pressure available over the entire rotational speed range.

It is furthermore disadvantageous in the case of electrohydrostatic drives with shaft sealing rings known in the prior art that the maximum working pressure of the accumulator and thus the maximum pressure difference is limited by the maximum rotational speed-dependent operating pressure of the shaft sealing ring. The accumulator in the hydraulic system assumes the function of preloading the hydraulic system and must absorb the entire alternating volume flow between the piston side and rod side of the differential cylinder. The size, or the volume, of the accumulator depends to a significant degree on the size of the alternating volume flow between the piston side and rod side of the differential cylinder, the dynamic/thermal utilization (adiabatic-isothermal), and the permissible pressure difference between the minimum and maximum filling of the accumulator. Thus, the necessary accumulator volume would decrease with a higher pressure difference between the minimum and maximum filling of the accumulator. By limiting the working pressure in electrohydrostatic drives with a shaft sealing ring, correspondingly larger accumulators with more capacity volume are necessary, which lead to a functionally more complex and costly construction of the accumulator and of the supply of the hydraulic system.

Starting with this prior art, the object of the present invention is to at least partially overcome the disadvantages of the prior art, or to improve the prior art.

In a first aspect of the present invention, this object is achieved by an electrohydrostatic drive having the features specified in claim 1. Preferred embodiments and modifications are the subject matter of the subclaims.

In a first aspect, the invention provides an electrohydrostatic drive comprising an electromechanical drive with a rotating drive shaft and a first receiving unit, wherein the electromechanical drive is arranged in the first receiving unit.

The electromechanical drive furthermore comprises a pump unit and a second receiving unit, wherein the pump unit is arranged in the second receiving unit and the second receiving unit contains a transport fluid.

Furthermore, the first receiving unit and the second receiving unit are arranged in contact with one another so that the electromechanical drive and the pump unit are connected to one another via the drive shaft.

The electromechanical drive furthermore comprises a slide ring seal, wherein the slide ring seal is arranged along the direction of extent of the drive shaft between the electromechanical drive and the pump unit such that the first receiving unit with the electromechanical drive and the second receiving unit with the pump unit are connected along the rotating drive shaft in a fluid-tight manner with respect to one another by the slide ring seal.

Electrohydrostatic drives are distinguished by their compact design and can be regulated in terms of rotational speed. The first receiving unit represents the installation space for receiving the electromechanical drive and additionally comprises air as a filling medium. The second receiving unit represents the installation space for receiving the pump unit and is additionally filled with a transport fluid, preferably with a hydraulic mineral oil. Preferably formed between the first receiving unit and the second receiving unit is a third installation space, in which the slide ring seal is arranged along the direction of extent of the drive shaft, which connects the first receiving unit and the second receiving unit in a fluid-tight manner with respect to one another.

In one embodiment, the pump unit is a hydrostatic pump.

In one embodiment, the slide ring seal comprises a slide ring, a slide ring carrier, a compression spring and a counter ring, wherein the compression spring exerts a counterpressure on the slide ring carrier in such a way that the slide ring rests in a fluid-tight manner against the counter ring along the rotating drive axle by means of the counterpressure provided via the slide ring carrier.

In one embodiment, the pump unit comprises a bushing for receiving the drive shaft in a clamping manner.

In one embodiment, the pump unit comprises a housing internal pressure in a range from 4 to 30 bar, in particular in a range from 10 to 25 bar, preferably of 20 bar.

The invention furthermore provides, in another aspect, an electrohydrostatic drive system having the features specified in claim 6.

In a second aspect, the invention provides an electrohydrostatic drive system comprising at least one electrohydrostatic drive according to one of claims 1 to 5 and a control block for controlling an actuator. Preferred embodiments and modifications are the subject matter of the subclaims.

In one embodiment, the actuator is a hydraulic cylinder, in particular a differential cylinder.

In another aspect of the present invention, the electrohydrostatic drive system according to the second aspect of the present invention can be used to drive a rapid traverse and/or power mode of a hydraulic cylinder and/or a press assembly, such as an extruder or a deep drawing press.

The present invention is based on the knowledge that electrohydrostatic drives with a slide ring seal can provide a higher pressure for hydraulic applications, for example for driving a differential cylinder, at a design-dependent maximum rotational speed, before wear and/or loss of the sealing effect of the seal occurs. In the event of leakage and a transfer of the mineral oil into the first receiving unit with the electromechanical drive, this would result in the destruction of the electromechanical drive.

Advantageously, 5-7 times the pressure of an electrohydrostatic drive with a shaft sealing ring can be obtained by an electrohydrostatic drive with a slide ring seal. The field of application and the scope of application of the electrohydrostatic drive are thus increased.

Damage or destruction of the seal is advantageously avoided since a slide ring seal is more robust against mechanical loading, in particular in the contact area of dynamic and static components.

In addition, it is advantageous that a slide ring seal can be used with special liquids and thus seal in the case of chemical liquids.

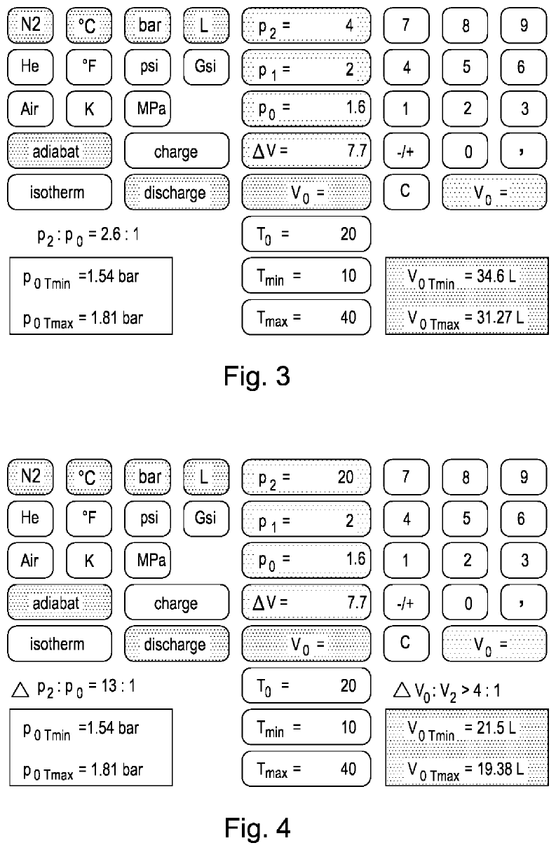

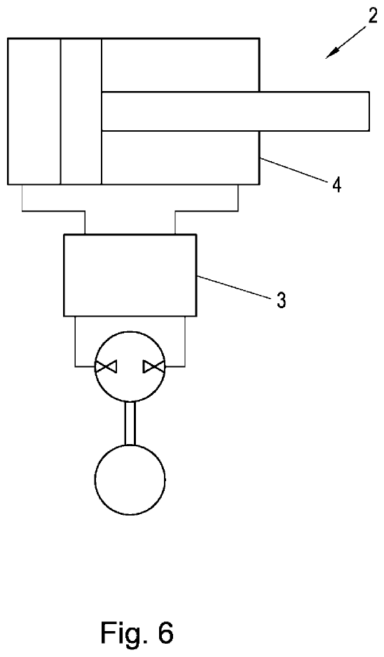

Advantageously, a hydraulic actuator, for example a differential cylinder, can be operated at a reduced accumulator volume. Due to its design, a differential cylinder comprises two pressurizable surfaces of different sizes. A differential cylinder is shown in FIG. 6. The left side of the differential cylinder comprises a larger surface to be pressurized than the right side of the differential cylinder comprising the cylinder rod. In this respect, different volume flows result for actuating the differential cylinder, or a larger volume flow is required to actuate the differential cylinder than the volume discharged into the hydraulic system via the right side. In addition, less volume flow is required to actuate the differential cylinder on the right side than is discharged to the hydraulic system via the left side. This difference in volume flow is provided by a hydraulic accumulator, for example a compensating tank. This hydraulic accumulator is preferably preloaded with an adjustable pressure. The greater the difference in area, the more volume and more accumulator must be provided in order to achieve compensation. With a higher pressure in the system, provided by the electrohydrostatic drive, the accumulator required for preloading can advantageously be reduced, as shown in FIG. 3 and FIG. 4. The size of the accumulator and thus of the hydraulic system are reduced and costs for the hydraulic system are lowered. In addition, the overall hydraulic system can be designed to be more compact.

The invention is explained in the following on the basis of various embodiments, wherein it is pointed out that this example also includes modifications or additions as would be apparent to a person skilled in the art. Moreover, this preferred exemplary embodiment is not a limitation of the invention in that modifications and additions are within the scope of the present invention.

Here, the following show:

FIG. 1 an electrohydrostatic drive with a shaft sealing ring;

FIG. 2 a diagram of the operating range of a shaft sealing ring;

FIG. 3 the needed storage size of the accumulator when using a shaft sealing ring;

FIG. 4 the needed storage size of the accumulator when using a slide ring seal;

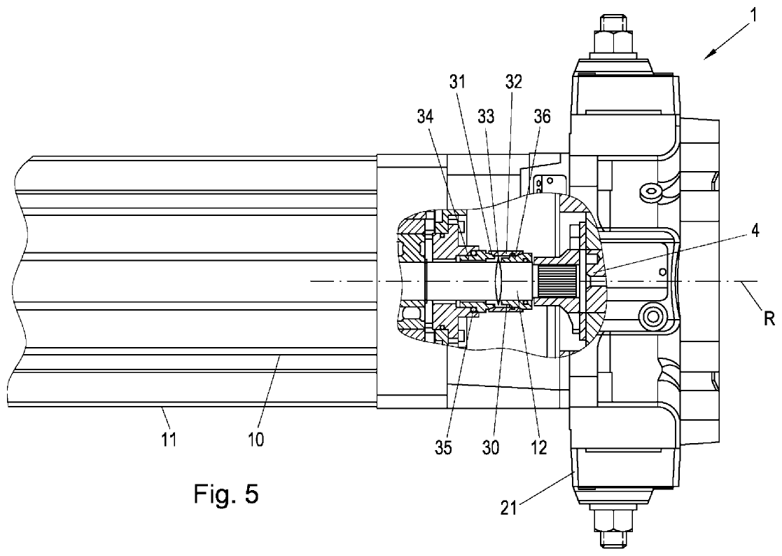

FIG. 5 an electrohydrostatic drive with a slide ring seal according to an embodiment of the present invention;

FIG. 6 an electrohydrostatic drive system with an electrohydrostatic drive according to an embodiment of the present invention.

FIG. 1 shows an electrohydrostatic drive with a shaft sealing ring known from the prior art. The electrohydrostatic drive comprises a first receiving unit with an electromechanical drive and a second receiving unit with a pump unit. The shaft sealing ring is arranged between the electromechanical drive and the pump unit so that the first receiving unit and the second receiving unit are connected along the rotating drive shaft in a fluid-tight manner by the shaft sealing ring. The shaft sealing ring seals the first receiving unit against ingress of mineral oil with respect to the second receiving unit up to a pressure of 10 bar at a design-dependent rotational speed. Once a design-dependent maximum rotational speed has been reached, the pressure must be reduced since as a result of the mechanical load, the shaft sealing ring no longer ensures sealing at too high a pressure.

FIG. 2 shows a diagram of the operating range of a shaft sealing ring. The ordinate axis of the diagram describes the permissible maximum pressure in the second receiving unit 21 with the pump unit 20. The maximum permissible pressure in an electrohydrostatic drive with a shaft sealing ring is 10 bar. The abscissa axis of the diagram describes the rotational speed of the drive shaft in rotations per minute (rpm). In the diagram in FIG. 2, four characteristic curves (A, B, C, D) for four electrohydrostatic drives with a shaft sealing ring in different sizes (pump conveying volumes 250 cm³, 80 cm³, 32 cm³, 19 cm³) are shown.

The shaft sealing ring has the task of realizing a medium separation between the first receiving unit and the second receiving unit via the rotating drive shaft. The permissible maximum pressure in the second receiving unit depends on the size of the pump unit (diameter of the drive shaft) and the rotational speed of the drive shaft (relative speed between the drive shaft and the sealing lip). The larger the size of the pump unit, the lower the permissible maximum rotational speed.

For an electrohydrostatic drive with the size of 19 cm³ (EPU019), for example, the maximum pressure in the second receiving unit is 10 bar up to a rotational speed of approximately 1,900 rpm. With a further increase in the rotational speed, the maximum permissible pressure decreases according to the characteristic curve D and is reduced to a value of 4 bar at a rotational speed of 4,500 rpm. The increase in the rotational speed also increases the mechanical load acting on the shaft sealing ring, for example by friction. Thus, the pressure within the second receiving unit has to be lowered in order to avoid damage to the seal and thus ingress of mineral oil into the first receiving unit. However, especially for the use of an electrohydrostatic drive in an autonomous with an integrated differential cylinder, it is desirable to have a higher housing pressure available over the entire rotational speed range. In an electrohydrostatic drive with a slide ring seal, it is advantageously possible to realize a housing pressure in a range from 4 to 30 bar, in particular in a range from 10 to 25 bar, preferably of 20 bar. Thus, at a design-dependent maximum rotational speed, for example 4500 rpm, a multiple of the pressure as with electrohydrostatic drives with a shaft sealing ring (for example 5-7 times) can be provided for specific hydraulic applications.

FIG. 3 and FIG. 4 show a simulation for the accumulator dimensioning of an accumulator volume in a hydraulic system. In particular, FIG. 3 shows the dimensioning of an accumulator volume in a hydraulic system with an electrohydrostatic drive comprising a shaft sealing ring and FIG. 4 shows the dimensioning of an accumulator volume in a hydraulic system with an electrohydrostatic drive comprising a slide ring seal, or an electrohydrostatic drive is simulated with an applied pressure of 20 bar. The program “asp light” of the company Hydac was used to simulate the accumulator dimensioning. Using a differential cylinder with the following dimensions: piston diameter=203.2 mm, rod diameter=88.9 mm, stroke=1,238.3 mm with an electrohydrostatic drive results in a necessary accumulator volume when using a shaft sealing ring for sealing (gas: N2, p2=4 bar, p1=2 bar, adiabatic, Tmin=10° C., Tmax=40° C., To=20° C.) of 35 l.

When the pressure p2, shown in FIG. 4, is increased to 20 bar, a necessary accumulator volume of 21.5 l and thus a difference in the accumulator volume in a range from 12.8 l to 13.2 l results. This advantageously leads to a smaller necessary accumulator and thus less installation space. Furthermore, it can lead to cost savings in the overall hydraulic system. It is furthermore advantageous that electrohydrostatic drives with a slide ring seal can be used in hydraulic systems which require a compact design of the drives due to lack of available space and nevertheless require a correspondingly high pressure for specific functions. This results from the fact that the decentralized, autonomous axle can be made even more compact by the smaller design of the accumulator.

FIG. 5 shows an electrohydrostatic drive 1 with a slide ring seal 30 according to an embodiment of the present invention. The basic construction of a slide ring seal 30 is shown in the enlarged section of FIG. 5. The electrohydrostatic drive 1 comprises an electromechanical drive 10 with a rotating drive shaft 12 and a first receiving unit 11, wherein the electromechanical drive 10 is arranged in the first receiving unit 11. Furthermore, the electrohydrostatic drive 1 comprises a pump unit 20 and a second receiving unit 21, wherein the pump unit 20 is arranged in the second receiving unit 21 and the second receiving unit 21 contains a transport fluid, for example a mineral oil. The first receiving unit 11 and the second receiving unit 21 are arranged in contact with one another so that the electromechanical drive 10 and the pump unit 20 are connected to one another via the drive shaft 12. Furthermore, the electrohydrostatic drive 1 comprises a slide ring seal 30, wherein the slide ring seal 30 is arranged along the direction of extent R of the drive shaft 12 between the electromechanical drive 10 and the pump unit 20 such that the first receiving unit 11 with the electromechanical drive 10 and the second receiving unit 21 with the pump unit 20 are connected along the rotating drive shaft 12 in a fluid-tight manner with respect to one another by the slide ring seal 30.

The electrohydrostatic drive 1 is a compact drive in which the electromechanical drive 10 and the pump unit 20 form a closed unit and the slide ring seal 30 serves to realize a medium separation (air/hydraulic fluid) between the first receiving unit 11 and the second receiving unit 21 via the rotating drive shaft 12.

The slide ring seal 30 comprises a slide ring 31, a slide ring carrier 32, a compression spring 33 and a counter ring 34, wherein the compression spring 33 exerts a counterpressure on the slide ring carrier 32 in such a way that the slide ring 31 rests on the counter ring 34 in a fluid-tight manner along the rotating drive shaft 12 by means of the counterpressure provided via the slide ring carrier 32. The static sealing with respect to the first receiving unit 11 or to the second receiving unit 21 takes place via an O-ring 35 against the counter ring 34. Mounted on the drive shaft 12 is a driver 36 which rotates at the rotational speed of the drive shaft. A static O-ring sealing takes place on the one hand between the drive shaft 12 and the driver 36 and on the other hand between the driver 36 and the slide ring carrier 32. The actual slide ring 31 is pressed against the counter ring 34 via a compression spring 33 in the slide ring carrier 32 and realizes the dynamic seal between the slide ring 31 and the counter ring 34.

The slide ring seal 30 is of more complex design in the number of individual elements and has larger axial dimensions due to design and structure than the shaft sealing ring shown in FIG. 1. As a result of the larger dimensions of the slide ring seal, the total length of the electrohydrostatic drive increases in comparison with the embodiment of an electrohydrostatic drive comprising a shaft sealing ring. The drive shaft 12 of the electromechanical drive 10 of the electrohydrostatic drive 1 with the slide ring seal 30 and the connecting flange between the electromechanical drive 10 and the pump unit 20 are made longer for receiving the slide ring seal 30 along the direction of extent R of the drive shaft 12. Furthermore, this comprises a design-related and structural reconfiguration of the first receiving unit 11 and of the second receiving unit 21, which comprises a corresponding enlargement and adaptation of the first receiving unit 11 and of the second receiving unit 12.

FIG. 6 shows an electrohydrostatic drive system 2 comprising at least one electrohydrostatic drive 1 and a control block 3 for controlling an actuator 4. The actuator 4 is a hydraulic cylinder, in particular a differential cylinder. The differential cylinder can be connected to a tool. The electrohydrostatic drive system 2 furthermore comprises a hydraulic accumulator (compensating accumulator) (not shown) for compensating the alternating volume.

### LIST OF REFERENCE SIGNS

1 Electrohydrostatic drive
2 Electrohydrostatic drive system
3 Control block
4 Actuator
10 Electromechanical drive
11 First receiving unit
12 Drive shaft
20 Pump unit
21 Second receiving unit
22 Bushing
30 Slide ring seal
31 Slide ring
32 Slide ring carrier
33 Compression spring
34 Counter ring
35 O-ring
36 Driver
A-D Rotational speed characteristic curves

1. An electrohydrostatic drive comprising:
an electromechanical drive with a rotating drive shaft and a first receiving unit, wherein the electromechanical drive is arranged in the first receiving unit;
a hydrostatic pump and a second receiving unit, wherein the hydrostatic pump is arranged in the second receiving unit and the second receiving unit contains a transport fluid;
the first receiving unit and the second receiving unit arranged in contact with one another so that the electromechanical drive and the hydrostatic pump are connected to one another via the drive shaft; and
a slide ring seal, wherein the slide ring seal is arranged along the direction of extent of the drive shaft between the electromechanical drive and the hydrostatic pump such that the first receiving unit with the electromechanical drive and the second receiving unit with the hydrostatic pump are connected at least along the rotating drive shaft in a fluid-tight manner with respect to one another by the slide ring seal.

2. (canceled)

3. The electrohydrostatic drive according to claim 1, wherein the slide ring seal comprises a slide ring, a slide ring carrier, a compression spring and a counter ring, and wherein the compression spring exerts a counterpressure on the slide ring carrier such that the slide ring rests on the counter ring in a fluid-tight manner along the rotating drive axle by means of the counterpressure provided via the slide ring carrier.

4. The electrohydrostatic drive according to claim 1, wherein the hydrostatic pump comprises a bushing for receiving the drive shaft in a clamping manner.

5. The electrohydrostatic drive according to claim 1, wherein the hydrostatic pump comprises a housing internal pressure in a range from 4 to 30 bar.

6. The electrohydrostatic drive according to claim 1 and comprising an actuator and a control block for controlling the actuator.

7. The electrohydrostatic drive according to claim 6, wherein the actuator comprises a hydraulic cylinder.

8. A method of using the electrohydrostatic drive according to claim 7 comprising the step of driving a rapid traverse and/or a power mode of the hydraulic cylinder.

9. The electrohydrostatic drive according to claim 5, wherein the housing internal pressure is in a range from 10 to 25 bar.

10. The electrohydrostatic drive according to claim 9, wherein the housing internal pressure is 20 bar.

11. The electrohydrostatic drive according to claim 7, wherein the hydraulic cylinder is a differential cylinder.

12. The electrohydrostatic drive according to claim 6, comprising a press assembly and driving a rapid traverse and/or a power mode of the press assembly.

13. The electrohydrostatic drive according to claim 12, wherein the press assembly is an extruder or a deep drawing press.
